(19) United States
(12) Patent Application Publication
(10) Pub. No.: US 2006/0020495 A1
(43) Pub. Date: Jan. 26, 2006

(54) Healthcare Claims Processing Mechanism for a Transaction System

(76) Inventors: Michael Stephen Baker, Hurricane, WV (US); Stephen Reed Jenkins, Charleston, WV (US); John I Bornacorso, Melbourne, FL (US); Stephen James Platz, Charleston, WV (US)

Correspondence Address: MONIKA J. HUSSELL, 1600 LAIDLEY TOWER- SUITE 1700, 500 LEE STREET, CHARLESTON, WV, 25301, US

(21) Appl. No.: 10/710,552

(22) Filed: Jul. 20, 2004

(51) Int. Cl. G06Q 40/00

(52) U.S. Cl. 705/4; 705/2

(57) ABSTRACT

A structured healthcare claims processing mechanism for use with funded accounts (e.g., healthcare reimbursement arrangements, healthcare savings accounts and flexible spending accounts) is disclosed, including a claims processing mechanism, a registration mechanism, a claim submission mechanism, a payment mechanism and an insurance submission mechanism.

### BRIEF DESCRIPTION OF DRAWINGS

In the accompanying drawings:

FIGS. 1 and 2 show overviews of a transaction system or aspects thereof according to embodiments of the present invention; and

FIG. 3 is a flowchart depicting the operation of aspects of a transaction system according to embodiments of the present invention.

### DETAILED DESCRIPTION

The term “message” generally refers to a signal representing a digital message. As used herein, the term “mechanism” is used herein to represent hardware, software or any combination thereof. The mechanisms and databases described herein can be implemented on standard, general-purpose computers or they can be implemented as specialized devices. The mechanisms may operate electronically, optically or in any other fashion. The term “person” means any individual, group of individuals, business entity or entities (including without limitation not-for-profit entities). The term “database” means one or more servers for storage of information.

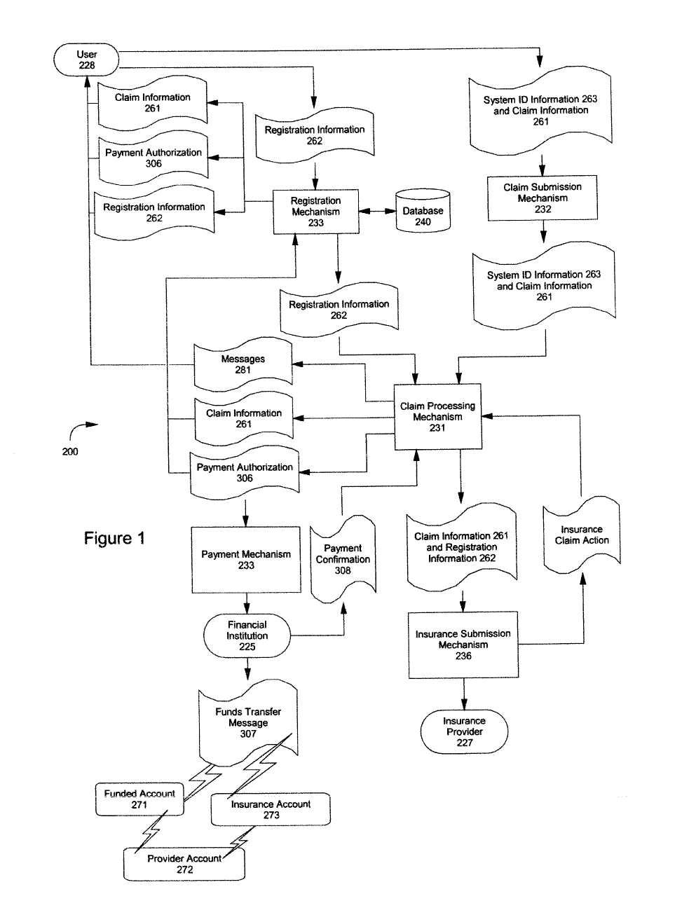

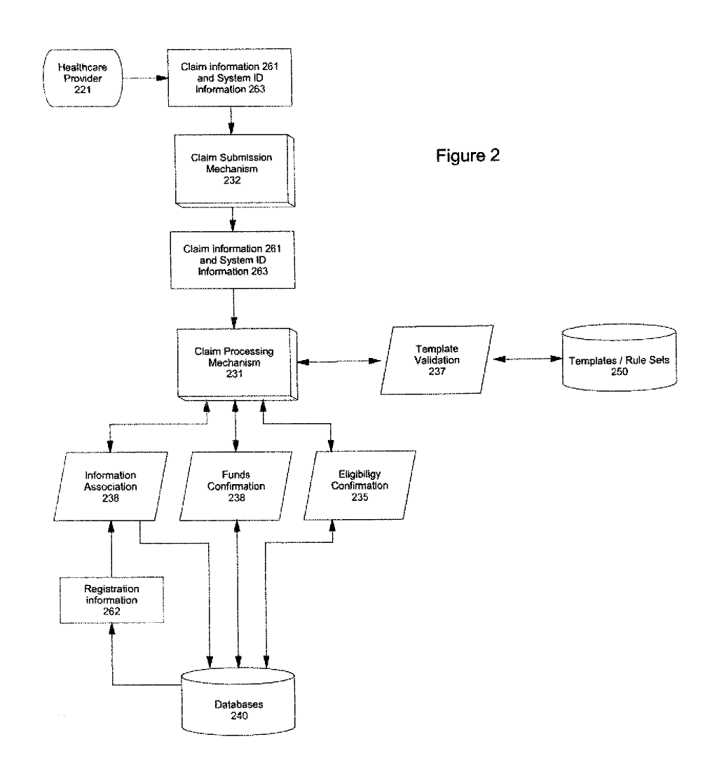

An overview of the structured transaction system 200 according to the present invention is described with reference to FIGS. 1 and 2. A participating employer has a healthcare plan for its eligible employees including an employer and/or individual employee account(s) (each a funded account 271, held by a financial institution 225), whereby the participating employer and/or its participating employees fund from time to time the funded account(s) 271. Examples of these accounts are healthcare reimbursement arrangements, healthcare savings accounts, and flexible spending accounts. The participating employees may use monies in the funded account(s) 271 for payment of healthcare expenses and services provided to the participating employee.

In many healthcare plans, dependants of an employee are entitled to participate in a healthcare plan sponsored by the employee's employer, and therefore a participating employee may (when permitted by the healthcare plan) fund an individual dependant account and/or use monies in the funded account(s) 271 for payment of healthcare expenses relating to his/her participating dependant, all in accordance with and subject to the limitations of the healthcare plan. Hereinafter, and in the drawings, participating employees and their participating dependants may be referred to as “participants”; however, it is recognized that in many uses of the term “participants,” the participating employee will be acting on behalf of one of its participating dependants.

The funded accounts 271 are managed in part by an administrator by means of the claim processing mechanism 231 of the present invention. The claim processing mechanism 231 from time to time receives from a participating healthcare provider 221 or a participant, by means of the claim submission mechanism 232, a claim 261 specifying healthcare services and expenses provided to a participant, and requesting payment or reimbursement for the same; the claim processing mechanism 231 processes the claim 261 and, if valid, instructs the financial institution 225 holding the funded account 271, by means of the payment mechanism 233, to pay the claim amount specified in the claim 261, as the same may be adjusted by the claim processing mechanism 231.

Some or all of the participating employer, participating employee, healthcare provider 221, insurance provider or healthcare plan administrator 227 and/or financial institution 225 (some of the “users” 228 of the system) may register with the administrator by means of the registration mechanism, whereby the user 228 transmits to the database 240 registration information 262 regarding the user 228 and in some cases registration information 262 regarding some of the other users 228, which registration information 262 will assist in claims processing, payment and account management of the various mechanisms of embodiments of the present invention. The registration information 262 may be reviewed and/or modified from time to time by the applicable user(s) 228 or the administrator. It should be understood that under some circumstances two or more of the users 228 may be the same person.

The administrator may contract with any of the users 228 of the system of the present invention or any portion or embodiment thereof regarding any, some or all of the following: authorization to pay claims 261, fees to be paid to the administrator, rates for services provided by a healthcare provider 221 to participants, parameters for submission of claims 261, allocations of risk, and terms of use of the system of the present invention or any portion or embodiment thereof.

Each participating employer, healthcare provider 221 and/or insurance provider or healthcare plan administrator 227 may assist the administrator in developing one or more template(s) and/or rule set(s) 250 against which some or all claims 261 relating to the participating employer (where its participants receive the services reflected in a claim), the healthcare provider 221 (where it provides the services reflected in a claim), and/or the insurance provider or healthcare plan administrator 227 (where the services reflected in a claim relate to services insured or administered by the insurance provider 227) shall be compared. The template(s) and/or rule set(s) 250 may vary among participating employers, healthcare providers 221 and/or insurance providers 227, or may be a single or group of template(s) and/or rule set(s) 250 against which some or all claims are compared. The template(s) and/or rule set(s) 250 may be structured by the terms and conditions of the healthcare plan, and may include treatment codes and payment rates.

At the time healthcare services are rendered to a participant, the participant may present system identification information 263 to the healthcare provider(s) 221, sufficient to identify the participant in the system of the present invention. The healthcare provider 221 transmits this information, along with claim information 261 relating to the services provided to the participant, to the claim processing mechanism 231 of the present invention by means of the claim submission mechanism 232; alternatively, a participating employee may submit the claim directly to the claim processing mechanism 231 by means of the claim submission mechanism 232.

The claim processing mechanism 231 may then perform some or all of the following steps: confirm that the participant is enrolled (eligibility confirmation 235); attach or incorporate certain information as regards the participant, the applicable employer, the healthcare provider 221, the funded account 271 and the provider's account 272 (which information was gathered through the registration process by any or each of them and is stored in the database 240) to the claim information submitted (information association 236); compare the claim information 261 to the applicable template(s) and rule set(s) 250 (template validation 237); and confirm that the applicable funded account 271 has sufficient funds available to the participant to satisfy the claim 261 in whole or in part (funds confirmation 238). Upon completion of any or all of said steps, the claim processing mechanism 231 may transmit a message 306 to the financial institution 225 holding the funded account 271 to transfer the claim amount (or lesser amount) from the funded account 271 to the applicable user account 272. The financial institution 225, after receipt of claim payment authorization 306, issues fund transfer instructions 307 causing funds to be transferred from the funded account 271 to the applicable user account 272; upon successful transfer of the funds, the financial institution 225 may generate a transfer confirmation message 308 to the claims processing mechanism 231. The claim processing mechanism 231 may further transmit the claim information 261, applicable registration information 262 and payment authorization 306, reformatted and filtered as desirable, to the insurance provider 227 by means of the insurance submission mechanism 236.

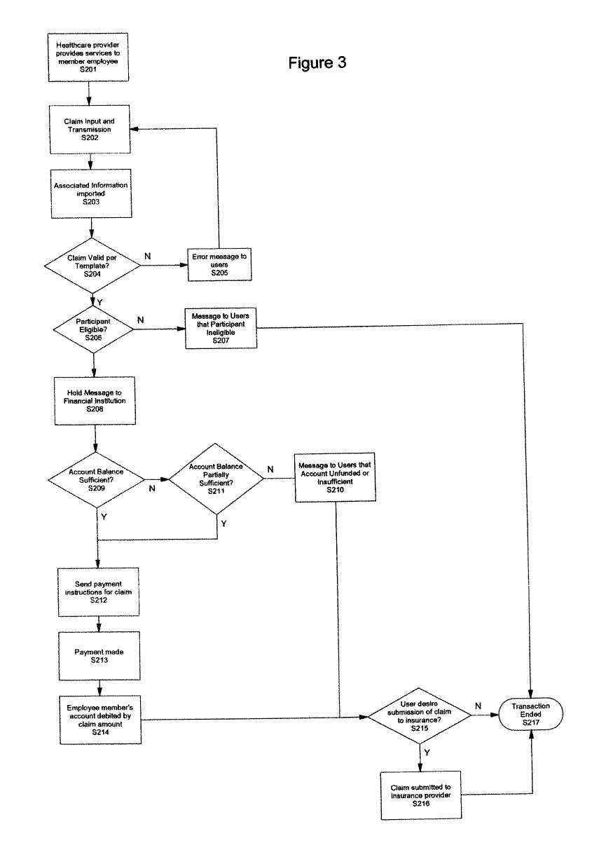

1. Claim processing Referring to FIGS. 1, 2 and 3, when a healthcare provider 221 provides healthcare services to a participant (at S201), the participant provides system identification information 263 to the healthcare provider 221, who then inputs and transmits (at S202) the claim information 261 for said services and the participant's system identification information 263 to the claim processing mechanism 231, by means of the claim submission mechanism 232. Multiple claims 261 for one or more participants may be entered by the healthcare provider 221 sequentially in a batch. Upon receipt of the message comprising the claim information 261, the claim processing mechanism 231 then performs some or all of the following steps, in any logical order:

(a) Associating Registration Information

Some registration information 262 regarding the healthcare provider 221, the participant, the applicable participating employer, the funded account 271, the participant's balance in such funded account 271, and the healthcare provider's account 272, all as may be stored in the database 240, is transferred to the claim processing mechanism 231 by means of the registration mechanism 234 and is attached to, incorporated in or otherwise associated with the claim information 261 (at S203, information association 236).

(b) Validation of Claims to Template/Rule Sets

The claim information 261 is compared to the applicable template(s) and/or rule set(s) 250 (at S204, template validation 237). If the claim information does not comply with the applicable template(s) and/or rule set(s) 250, a message 281 to that effect may be generated and transmitted (at S205) to some or all of the users 228. The healthcare provider 221 may then correct and retransmit the claim information 261 (at S202), or the corrections thereto, to the claim processing mechanism 231, by means of the claim submission mechanism 234, for comparison to the applicable template(s) and/or rule set(s) 250. The corrections to the claim information 261 may be attached to, incorporated in, or otherwise associated with the claim information 261, or the corrections may modify the claim information 261 as originally submitted by the healthcare provider 221.

The claim processing mechanism 231 may also calculate applicable rates for services and expenses claimed, in accordance with the applicable template(s) and/or rule set(s) 250, which may then be appended to, incorporated in or otherwise associated with the claim information 261.

(c) Participant Eligibility Confirmation

The claim information 261 and some or all of the registration information 262 is compared to the database 240 (at S206, eligibility confirmation 235) to confirm the participant's eligibility. If the database 240 reflects that the participant is no longer an eligible participant, a message 281 to that effect may be generated and transmitted to some or all of the users 228 (at S207).

(d) Funds Query

The claims processing mechanism 231 compares the claim amount to the applicable funded account 271 balance (at S209 and s211, funds confirmation 237) and the participant's balance therein, as may be reflected in the database 240 and/or the financial institution's account records. If there are insufficient funds to which the participant is entitled in the funded account 271, a message 281 to that effect may be generated and transmitted to some or all of the users 228 (at S210). In the event there are funds in the funded account 271 to which the participant is entitled, but they are insufficient to satisfy the entire claim amount, a message 281 to that effect may be generated and transmitted to some or all of the users 228 (at S210), and the healthcare provider 221 may be paid via the payment mechanism 233 for a portion of the claim amount from the funded account 271.

A hold message 282 may be generated and transmitted (at S208) by the claim processing mechanism 231 (at S207) to the payment mechanism 233/financial institution 225 (at S207), authorizing and instructing the financial institution to hold sufficient funds in the funded account 271 to satisfy the amount of the claim 261 or, if the participant's balance of the funded account 271 is insufficient to satisfy the claim, to hold the remainder of the participant's balance of the funded account 271 or some lesser amount. The financial institution 225 may transmit a confirmation message 283 which, in the case of insufficient funds to pay the claim in full, may include the amount available in the funded account or some lesser amount, to the claim processing mechanism 231, confirming that a hold has been placed as requested; the claim processing mechanism 231 may then transmit to some or all of the users 228 a message 281 to the same effect (which may be the same as the confirmation message 283).

(e) Approval or Denial of Claim

If the participant is enrolled, and if the participant's balance of the funded account 271 is sufficient to satisfy the claim in whole or in part, a message 281 may be transmitted to some or all of the users 228 indicating approval of the claim.

In the event a claim is denied by the claim processing mechanism 231 for any of the reasons set forth above or any other reason, a message 281 to that effect may be generated and transmitted to any, some or all of the users 228 indicating denial of the claim, and if desirable the reasons therefore.

(f) Payment Instructions

The claim information 261 and registration information 262, filtered as may be desirable or as is required by law, is transmitted (at S212) by means of the payment mechanism 233 to the financial institution 225, with instructions or authorization to transfer funds in the amount of the claim(s) (or portion thereof, as applicable) from the funded account 271 to the provider account 272.

The financial institution 225 may transmit a payment confirmation message 308 to the claim processing mechanism 231, confirming the transaction details and/or the funds transfer, which may be verified by the claim processing mechanism 231, and a message 281 to that effect may be transmitted to some or all of the users 228.

(g) Alternative Payment; Reversal of Charges

In some embodiments of the invention, the claim processing mechanism 231 will permit receipt and recordation of alternative payment information input by the healthcare provider 221 and transmitted to the claim processing mechanism 231 by means of the claim submission mechanism 232, reflecting the participant's payment of amounts due to the healthcare provider 221 independent of the payment(s) made by the financial institution 225 from the funded account 271. As an additional feature, the claim processing mechanism 231 may process non-cash (e.g. credit card) payments for the benefit of the healthcare provider 221, information regarding the same being transmitted to the claim processing mechanism 231 by the claim submission mechanism 232.

In an embodiment of the present invention, reversal of charges may be made by the claim processing mechanism 231 by means of the claim submission mechanism 232 or the registration mechanism 233 upon the request of one or more of the users 228.

(h) Funding of Accounts.

In some embodiments of the claims processing mechanism of the present invention, a participating employer or participating employee may fund the funded accounts from other banking accounts of the user 228, by providing (during registration or otherwise) to the claims processing mechanism, by means of the registration mechanism, ancillary account information and funds transfer requests. The claim processing mechanism then generates and transmits an ancillary funds request on behalf of the user 228 to the applicable ancillary financial institution, requesting the funds transfer. It is contemplated that the ancillary financial institution will then transmit a funds transfer instruction to electronically transmit funds from the ancillary account to the funded account. Confirmation of such transfer may be returned by the financial institution or the ancillary financial institution to the claims processing mechanism, which may then record the information in the database and may generate and transmit a message to that effect to the funder and/or any other user 228 confirming the same.

(i) Claim Submission to Insurance.

In some embodiments of the present invention, the claim processing mechanism 231 may generate and transmit, by means of the insurance submission mechanism 236, a message regarding the claim information 261 and applicable registration information 262, filtered and/or formatted as appropriate or desirable, to the insurance provider or healthcare plan administrator 227 or any person acting on either of their behalf, for further processing by the insurance provider 227 relating to, among other purposes, validating the claim for purposes of coverage under the healthcare plan, crediting the participant with expenses incurred towards his/her deductible, confirming accuracy and compliance of the claim with the insurance benefits, and providing payment to the participant or the healthcare provider 221, as applicable.

In a further embodiment of the present invention, the insurance provider or healthcare plan administrator 227 may transmit messages by the insurance claim mechanism 236 to the claims processing mechanism 231 for further processing for purposes such as authorizing payment of a claim from the insurance provider's account 273 to the provider's account 272 (or the employee's account, if any and applicable), and notice of payment or rejection of a claim to any of the users 228. In this embodiment, the system of the present invention may permit the resubmission of a rejected claim to the insurance provider 227 by means of the claim submission mechanism 232, the claim processing mechanism 231 and the insurance submission mechanism 236.

(j) Recordation of Data

The claim processing mechanism 231 records in the database 240 some or all of the information contained in the registration information 262, the claim information 261, the messages 281 transmitted to and/or received from the users 228 or the administrator by the registration mechanism 233, the claim submission mechanism 232, the claim processing mechanism 231, the payment mechanism 234, and/or the insurance submission mechanism 236, and other information which may be generated by any mechanisms of the embodiments of the present invention from time to time (e.g. invalid login).

2. Registration, Account Review and Management

An embodiment of the claim processing mechanism 231 of the present invention includes registration of the users 228, including any of a participating employer, a participating employee, a healthcare provider 221, a financial institution 225 and an insurance provider or healthcare administrator 227, and any persons acting on behalf of any of these persons, including for example but without limitation representatives, employees and agents, and any other users 228 of the system of the present invention or embodiments thereof.

Users 228 may register by providing registration information 262 (including personal or corporate identifying information and information regarding dependents and beneficiaries, healthcare plan terms and conditions, account numbers, etc.) to the claims processing mechanism 231, which then records the information to the database 240.

An embodiment of the registration mechanism 233 includes the performance of a query of third party credentialing databases to confirm licensure and good standing of participating healthcare providers 221 at registration, and/or from time to time thereafter.

By means of the claim processing mechanism 231, users 228 may from time to time add, delete and/or modify certain information in the database 240 relating to the user 228, the user's 228 account(s) (if any), or in the case of employers, enrollment or change of status of participating employees.

An embodiment of the registration mechanism 233 allows the users 228 to view information in their respective database 240 and/or generate standard or customized reports or forms from the information in the database 240, which can be transmitted to users 228 in a variety of formats, including without limitation claim information capable of being imported into a healthcare provider's practice management system, participating employer's healthcare payment system, and other financial software.

3. Information Management

The claim processing mechanism 231 may generate unique identification codes for the claim 261 and some or all of the messages 281 and/or records generated, transmitted or received thereby, which may tie all such messages and/or records to a single claim 261 and/or batch of claims. The unique identification codes, when generated, may be transmitted or posted with the messages 281/records.

4. Security

The database 240 and the mechanisms of the present invention may require various levels of security, including use of user 228 identification numbers or login names, login passwords, (which may be in the form of magnetically coded access cards containing authorization or other technology); information filters, varying among some or all of the users 228, thereby providing each user 228 access to limited information from the database 240; and VPN, firewalls, concentrator, PKI, SSL, and other transaction level security solutions in order to protect the privacy of the transactions and data in the database. It is contemplated that security of systems comprising the present invention will evolve over time, with improvements in the computer security industry and changes in privacy laws.

Thus, a claims processing mechanism and related mechanisms for a healthcare claims submission and payment system is provided. One skilled in the art will appreciate that the present invention can be practiced by other than the described embodiments, which are presented for purposes of illustration and not limitation, and the present invention is limited only by the claims that follow.

1. A healthcare claims management and payment transaction system comprising:
a registration mechanism constructed and arranged to generate and transmit a message representing registration information to the system;
a claim submission mechanism constructed and arranged to generate and transmit a message representing claim information to the system; and
a claim processing mechanism constructed and arranged,
to receive a message representing claim information generated and transmitted by the claim submission mechanism9
to receive a message representing registration information generated and transmitted by the registration mechanism, and
to generate and transmit a message representing payment authorization to a payment mechanism, the payment authorization being based at least in part on the registration information and the claim information.

2. The system of claim 1, wherein the registration mechanism is further constructed and arranged to receive a message representing registration information from one or more user.

3. The system of claim 1, wherein the claim submission mechanism is further constructed and arranged to receive a message representing claim information from one or more users.

4. The system of claim 1, wherein the claim processing mechanism is further constructed and arranged to generate and transmit a message representing claim information and payment authorization to the registration mechanism.

5. The system of claim 4, wherein the registration mechanism is further constructed and arranged to generate and transmit a message containing some or all of the claim information, registration information and/or payment authorization to one or more users

6. The system of claim 1, wherein the payment authorization is based in part on the claim information as compared to one or more templates and/or rule sets.

7. The system of any of claims 1-6, wherein the payment mechanism is constructed and arranged to receive a message containing payment authorization from the claim processing mechanism, and to generate and transmit a funds transfer message based upon such authorization to cause funds to be transferred from a funded account to a provider account.

8. The system of claim 1, wherein the claim processing mechanism is further constructed and arranged to generate and transmit a message representing some or all of the claim information, the registration information and/or the payment authorization to an insurance submission mechanism.

9. The system of claim 8, wherein
the insurance submission mechanism is further constructed and arranged to generate and transmit a message representing an insurance claim action;
the claim processing mechanism is further constructed and arranged to receive a message representing insurance claim action from the insurance submission mechanism, and to generate and transmit a second funds transfer message representing payment authorization to the payment mechanism, the payment authorization based at least in part on the insurance claim action and the registration information.

10. A method of managing and paying healthcare claims, the method comprising:
by a registration mechanism, generating a message representing registration information to the system;
by a claim submission mechanism, generating a message representing a healthcare claim to the system; and
by a claim processing mechanism, obtaining a message representing registration information generated by the registration mechanism,
obtaining a message representing a healthcare claim generated by the claim submission mechanism, and
generating and transmitting a message representing payment authorization to a payment mechanism, the payment authorization being based at least in part on the claim information and the registration information.

11. The method of claim 10 further comprising the claim submission mechanism receiving a message representing a healthcare claim from one or more users

12. The method of claim 10, further comprising the claim processing mechanism generating and transmitting a message representing the healthcare claim and the payment authorization to the registration mechanism.

13. The method of claim 10, wherein the payment authorization is based in part on the claim information as compared to one or more templates and/or rule sets.

14. The method of claim 10, further comprising the registration mechanism generating and transmitting a message containing some or all of the claim information, registration information and/or payment authorization to one or more users.

15. The method of any of claims 10-14, further comprising the payment mechanism receiving a message containing payment authorization from the claim processing mechanism, and generating and transmitting a message to cause funds to be transferred from a funded account to a provider account.

16. The method of claim 10, further comprising the claim processing mechanism generating and transmitting a message representing some or all of the claim information the registration information and/or the payment authorization to an insurance submission mechanism.

17. A memory for storing data for access by an application program being executed on a data processing system, comprising:
a data structure stored in the memory, said data structure including
information relating to one or more users issued by a registration server,
claim information relating to services performed by or on behalf of any of said one or more users, said claim information being issued by a claim submission server, and
payment authorization information issued by the data processing system of the present invention, said payment authorization being based at least on the registration information, the claim information and one or more templates and/or rule sets.

18. A system for managing, processing and paying healthcare claims, the system comprising:
a claims submission mechanism having means for issuing electronic signals representing claim information to the system;
a registration mechanism having means for issuing electronic signals representing registration information to the system; and
a claims processing mechanism comprising means for obtaining electronic signals representing claim information issued by the claims submission mechanism,
means for obtaining electronic signals representing registration information issued by the registration mechanism, and
means for issuing electronic signals representing payment authorization, the payment authorization being based at least on the claim information and the registration information.

19. The system of claim 18, wherein the registration mechanism further comprises means for obtaining an electronic signal representing registration information from one or more users, and the claim submission mechanism further comprises means for obtaining an electronic signal representing claim information from one or more users.

20. The system of claim 18, wherein the payment authorization is based further on the claim information as compared to one or more templates and/or rule sets.

21. The system in claim 18, further comprising a payment mechanism comprising means for obtaining electronic signals representing payment authorization from the claim processing mechanism, and means for issuing electronic signals to cause funds to be transferred from a funded account to a provider account.

22. An apparatus for managing, processing and paying healthcare claims, the apparatus comprising:
a mechanism constructed and adapted to receive a message representing registration information;
a mechanism constructed and adapted to receive a message representing healthcare claim information; and
a mechanism constructed and adapted to generate and transmit a message representing payment authorization.

23. The apparatus of claim 22, wherein the mechanism is further constructed and adapted to generate and transmit a message containing claim information and action to one or more users.

24. The apparatus of claim 22, wherein the payment authorization is based in part on the claim information as compared to one or more templates and/or rule sets.

25. The apparatus of any of claims 22-24, wherein the mechanism is further constructed and adapted to generate and transmit a message representing some claim information and registration information, to an insurance submission mechanism.

26. An apparatus for managing, processing and paying healthcare claims, the apparatus comprising:
means for receiving electronic signals representing a healthcare claim;
means for receiving electronic signals representing registration information;
means for generating a message based on the healthcare claim and the registration information, the message specifying payment authorization for a sum certain; and
means for transmitting electronic signals representing the payment authorization message to a payment mechanism.

27. The apparatus of claim 26, further comprising means for transmitting electronic signals representing claim information and payment authorization to a registration mechanism.

28. The apparatus of claim 26, wherein the payment authorization is based further on the claim information as compared to one or more templates and/or rule sets.

29. The apparatus of any of claims 26-28, further comprising means for transmitting electronic signals representing some claim information, registration information and payment authorization to an insurance submission mechanism.

30. Computer readable media tangibly embodying a program of instructions executable by a computer to perform a method of managing, processing and paying healthcare claims in an electronic transaction system, the method comprising, by a claims processing mechanism:
receiving electronic signals representing claim information from a claims submission mechanism;
receiving electronic signals representing registration information from a registration mechanism;
creating a message based on claim information and registration information, the message specifying claim payment authorization; and
sending electronic signals representing the message to a payment mechanism requesting claim payment.

31. At least one computer programmed to execute a process for managing, processing and paying claims, the process comprising:
receiving electronic signals representing a claim;
receiving electronic signals representing registration information;
creating a payment authorization message specifying payment of the claim; and
causing electronic signals representing the payment authorization message to be sent to a payment mechanism.

32. The computer of claim 31, wherein the payment authorization is based in part on the claim information as compared to one or more templates and/or rule sets.

33. The computer of claim 32, wherein the process further comprises
creating a message representing some claim information, registration information and payment authorization; and
causing electronic signals representing the message to be sent to an insurance submission mechanism.
